(19) United States
(12) Patent Application Publication
(10) Pub. No.: US 2026/0320650 A1
(43) Pub. Date: Oct. 15, 2026

(54) ADVERTISEMENT APPARATUS

(71) Applicants: Takahito SAIGO, Iwate (JP); Masato Ikeda, Saitama (JP); Yukihiro Takasa, Kanagawa (JP)

(72) Inventors: Takahito SAIGO, Iwate (JP); Masato Ikeda, Saitama (JP); Yukihiro Takasa, Kanagawa (JP)

(21) Appl. No.: 19/640,874

(22) Filed: Apr. 7, 2026

Related U.S. Application Data
(63) Continuation of application No. 17/943,509, filed on Sep. 13, 2022.

(30) Foreign Application Priority Data
Sep. 15, 2021 (JP) 2021-149936

(51) Int. Cl. G06Q 30/0251; G06Q 30/0207; G06Q 30/0241

(52) U.S. Cl. CPC G06Q 30/0269; G06Q 30/0207; G06Q 30/0255; G06Q 30/0276

(57) ABSTRACT

Provided is an advertisement apparatus including a unit configured to calculate a similarity between second processing target information that is latest information related to a predetermined feature amount of second user information and first processing target information that is information in the same period as the second processing target information related to the predetermined feature amount of the first user information; a unit configured to create advertisement information for providing notification of one advertisement application capable of receiving an advertisement, installed on a user terminal identified by user terminal identification information, based on an analysis result obtained by analyzing the first user information in a period after an observation period of the second processing target information; and a unit configured to provide notification of the advertisement information by designating the user terminal identification information and the one advertisement application.

### CROSS-REFERENCE TO RELATED APPLICATIONS

This application is a continuation of U.S. application Ser. No. 17/943,509 filed on Sep. 13, 2022, claiming the benefit of priority of Japanese Patent Application No. 2021-149936 filed on Sep. 15, 2021. The entire disclosures of the above-identified applications, including the specifications, drawings, and claims are incorporated herein by reference in their entirety.

### BACKGROUND OF THE INVENTION

### 1. Technical Field The present invention relates to a technique for notifying a user terminal of advertisement information.

### 2. Description of the Related Art

An advertisement is to actively widely advertise information on a product or service to the public, and is performed for promoting sales of the product or service.

Conventionally, an advertisement related to a product or service has been frequently performed, but it has been difficult to implement an effective advertisement.

Under such circumstances, technology development for enhancing an effect of an advertisement is actively performed. For example, JP 6125700 B1 proposes a technology for appropriately determining an advertisement to be distributed, and JP 6026682 B1 proposes a technology for acquiring and accumulating information on a customer and information on a product purchased in a real shop in association with each other.

### SUMMARY OF THE INVENTION

However, in the above-described conventional technology, there is a problem that time series information related to a behavior or characteristic of a preceding person cannot be effectively utilized when creating an advertisement for a following person.

Therefore, in view of the above problem, an object of the present invention is to provide an advertisement apparatus that effectively utilizes time-series information related to a behavior or characteristic of a preceding person when creating an advertisement for a following person.

An aspect of an advertisement apparatus disclosed herein includes: a first user information storage unit configured to store first user information that is time-series information related to a behavior or characteristic of one user; a second user information storage unit configured to store second user information that is time-series information related to a behavior or characteristic of the other user and user terminal identification information that is information for specifying a user terminal when notification of an advertisement is provided by designating the user terminal operated by the other user and an application installed in the user terminal in association with each other; a similarity calculation unit configured to calculate a similarity between second processing target information that is information related to a predetermined feature amount of the second user information and first processing target information that is information in the same period as the second processing target information related to the predetermined feature amount of the first user information; an advertisement information creation unit configured to create, when the similarity is larger than a predetermined value, advertisement information for providing notification of one advertisement application capable of receiving an advertisement installed in the user terminal identified by the user terminal identification information based on an analysis result obtained by analyzing the first user information in a period after an observation period of the second processing target information; and an advertisement information notification unit configured to provide notification of the advertisement information created by the advertisement information creation unit by designating the user terminal identification information and the one advertisement application.

An aspect of the disclosed advertisement apparatus effectively utilizes time-series information related to a behavior or characteristic of a preceding person when creating an advertisement for a following person.

### BRIEF DESCRIPTION OF THE DRAWINGS

FIG. 1 is a diagram for describing an outline of an advertisement apparatus according to the present embodiment;

FIG. 2 is a functional block diagram of an advertisement apparatus according to the present embodiment;

FIG. 3 is a diagram for conceptually describing processing by an advertisement apparatus according to the present embodiment;

FIG. 4 is a diagram illustrating an example of a first user information storage unit according to the present embodiment;

FIG. 5 is a diagram illustrating an example of a second user information storage unit according to the present embodiment;

FIG. 6 is a diagram for describing processing by an advertisement information creation unit according to the present embodiment;

FIG. 7 is a diagram illustrating a hardware configuration example of an advertisement apparatus according to the present embodiment; and

FIG. 8 is a flowchart illustrating a flow of processing by an advertisement apparatus according to the present embodiment.

### DETAILED DESCRIPTION

An embodiment of the present invention will be described with reference to the drawings.

### Operation Principle of Advertisement Apparatus According to Present Embodiment

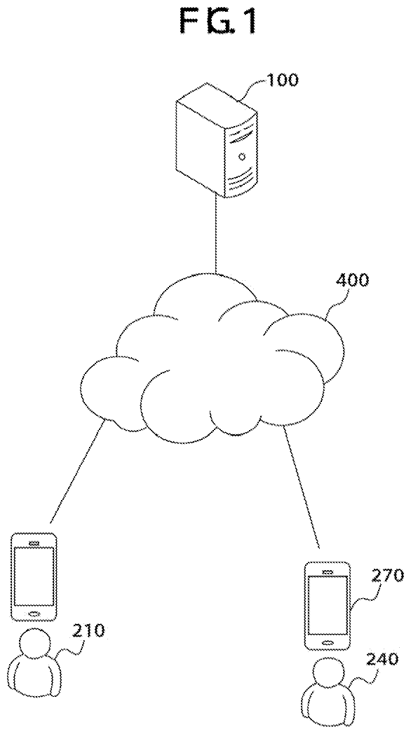

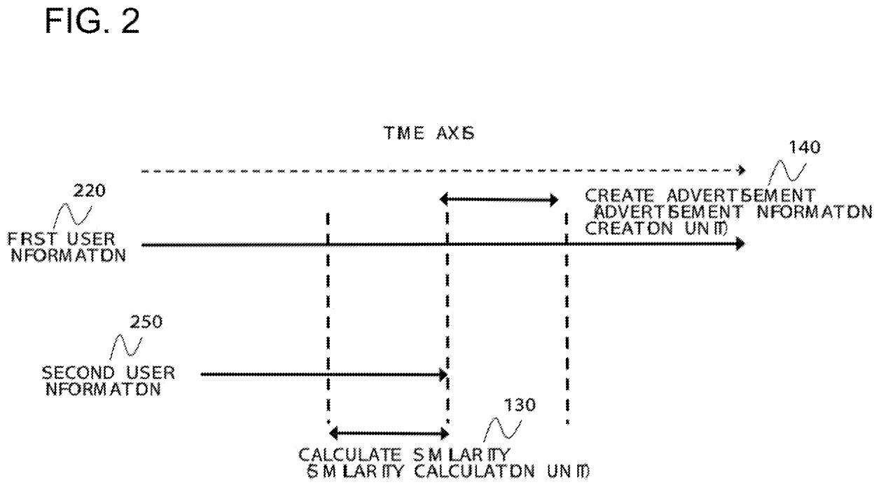

An outline of an advertisement apparatus (hereinafter, simply referred to as a “present apparatus”) 100 according to the present embodiment will be described with reference to FIGS. 1 and 2. FIG. 1 is a diagram for describing a coupling relationship between the present apparatus 100 and other apparatuses, and FIG. 2 is a diagram for conceptually describing processing by the present apparatus 100.

As illustrated in FIG. 1, the present apparatus 100 is coupled to a user terminal operated by one user 210 or a user terminal 270 operated by the other user 240 via a communication network 400. The communication network 400 may be in a wired form or a wireless form. The user terminal 270 may be a personal computer or a portable information terminal such as a smartphone.

As illustrated in FIG. 2, the present apparatus 100 provides an effective advertisement 320 to a target person 240 of data 250 having a relatively short accumulation period based on user data 220 accumulated over a relatively long period of time.

That is, the present apparatus 100 selects first user information 220 having a feature similar to a data characteristic in a latest period of second user information 250 (processing by a similarity calculation unit 130).

Then, the present apparatus 100 analyzes the selected first user information 220 in a period during which the second user information 250 is not observed, and extracts a preference tendency 340 in the first user information 220 (advertisement information creation unit 140). Moreover, the present apparatus 100 creates an advertisement 320 for the user 240 so as to match the extracted preference tendency 340 (advertisement information creation unit 140), and notifies the user terminal 270 of the created advertisement 320 (advertisement information notification unit 150).

As described above, the present apparatus 100 can effectively utilize the time-series information 220 related to a behavior or characteristic of a preceding person 210 when creating the advertisement 320 for a following person 240.

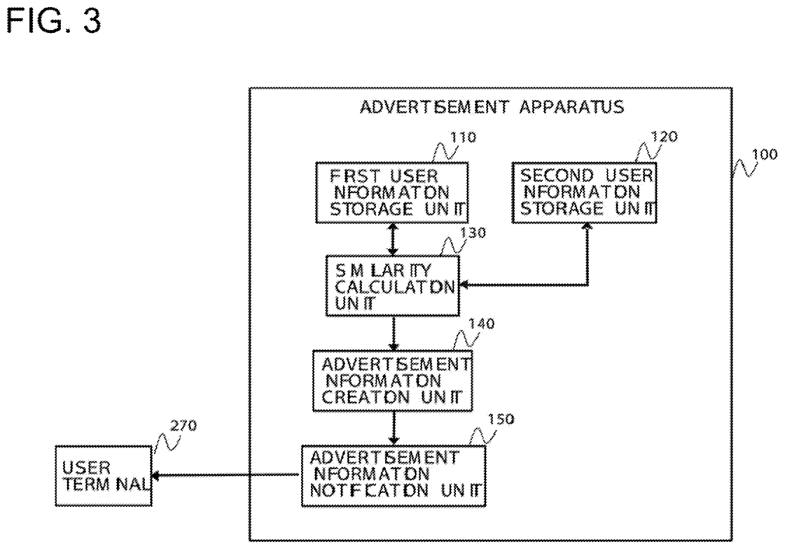

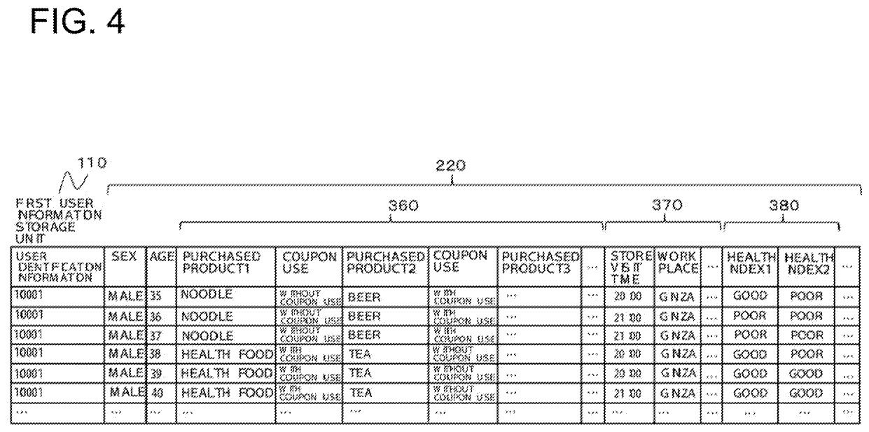

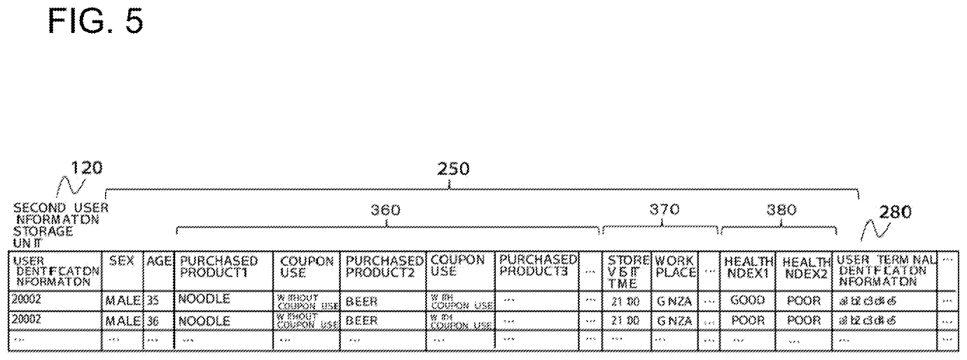

An operation principle of the present apparatus 100 will be described with reference to FIGS. 2 to 6. FIG. 3 is a functional block diagram of the present apparatus 100, FIG. 4 illustrates an example of a first user information storage unit 110, and FIG. 5 illustrates an example of a second user information storage unit 120.

As illustrated in FIG. 3, the present apparatus 100 includes the first user information storage unit 110, the second user information storage unit 120, the similarity calculation unit 130, the advertisement information creation unit 140, and the advertisement information notification unit 150.

The first user information storage unit 110 stores the first user information 220 that is the time-series information related to the behavior or characteristic of one user 210. The first user information 220 includes purchase history information 360 of one user 210 related to the product or service, and also includes information related to a history of cognition, acquisition, and use of a coupon 350 related to sales promotion of the product or the service. The first user information 220 includes information 370 related to a history of behaviors such as a store visit time, a stay time, the number of store visits, a product picked up, a use station, a work place, and a behavior area on holidays. In addition, the first user information 220 includes information 380 related to a history of health indexes such as a total cholesterol level, a neutral fat/blood sugar level, a skin condition, a blood pressure, DNA, and allergy. The first user information 220 includes user attribute information 390 such as a name, a sex, and an age. In addition, the first user information 220 may associate behavior (for example, a behavior of picking up a product or returning it to its original location) history information 370 for examining a product or service before purchase with the purchase history information 360 related to the product or service.

As illustrated in FIG. 4, the first user information storage unit 110 stores, for example, purchase history information 360 indicating that a male user 210 has purchased a noodle (without coupon use) and a beer (with coupon use) when the user is 35 years old. In addition, the first user information storage unit 110 stores, for example, purchase history information 360 indicating that the same user 210 has purchased health food (with coupon use) and tea (with coupon use) when the user is 38 years old.

In addition, the first user information storage unit 110 stores, for example, the behavior history information 370 indicating that a male user 210 visits a store on the way home from work (20:00 or 21:00) when the male user is 35 to 40 years old and a work place is in Ginza. In addition, the first user information storage unit 110 stores health index history information 380 indicating that the male user 210 has improved a health index 1 at the age of 38 and has improved a health index 2 at the age of 39. Note that the health index 1 and the health index 2 are, for example, information related to a total cholesterol level, a neutral fat/blood sugar level, a skin condition, a blood pressure, DNA, allergy, and the like.

The second user information storage unit 120 stores the second user information 250 which is the time-series information related to the behavior or characteristic of the other user 240, and user terminal identification information 280 in association with each other. The user terminal identification information 280 is information for specifying a user terminal 270 when notifying the advertisement 320 by designating the user terminal 270 operated by the other user 240 and an advertisement application 330 installed in the user terminal 270. The user terminal identification information 280 may be referred to as an advertisement ID, but is not limited thereto.

The second user information 250 includes the purchase history information 360 of the other user 240 related to the product or service, and also includes information related to a history of cognition, acquisition, and use of a coupon 350 related to sales promotion of the product or service. The second user information 250 includes information 370 related to a history of behaviors such as a store visit time, a stay time, the number of store visits, a product picked up, a use station, a work place, and a behavior area on holidays. In addition, the second user information 250 includes information 380 related to a history of health indexes such as a total cholesterol level, a neutral fat/blood sugar level, a skin condition, a blood pressure, DNA, and allergy. The second user information 250 includes user attribute information 390 such as a name, a sex, and an age. Note that the other user 240 is assumed to be younger in age than the one user 210. In addition, the second user information 250 may associate behavior (for example, a behavior of picking up a product or returning it to its original location) history information 370 for examining a product or service before purchase with the purchase history information 360 related to the product or service.

The similarity calculation unit 130 calculates a similarity between first processing target information 230 and second processing target information 260. Note that a method of calculating the similarity is not particularly limited as long as the similarity between the two pieces of information is represented by a numerical value. The second processing target information 260 is latest information related to a predetermined feature amount 300 of the second user information 250. The first processing target information 230 is information related to the predetermined feature amount 300 of the first user information 220 in the same period as the second processing target information 260.

As illustrated in FIG. 2, the second processing target information 260 is information related to the second user information 250, and is information related to the predetermined feature amount 300 in a latest predetermined period. The first processing target information 230 is information related to the first user information 220, and is information related to the predetermined feature amount 300 in the same period as the second processing target information 260, extracted for processing by the similarity calculation unit 130.

The predetermined feature amount 300 may be individual information of the user attribute information 390 such as an age, a purchased product, a work place, and a health index, the purchase history information 360, the behavior history information 370, and the health index history information 380, or time-series information thereof. Furthermore, the predetermined feature amount 300 may be information created by combining the user attribute information 390, the purchase history information 360, the behavior history information 370, and the health index history information 380, or time-series information thereof.

As illustrated in FIGS. 4 and 5, for example, in a case where the feature amount 300 is “age”, the similarity calculation unit 130 calculates a high similarity for information on a second line of the user 240 with the user identification information: 20002 with respect to information on a second line of the user 210 with the user identification information: 10001. Similarly, for example, in a case where the feature amount 300 is “health index 2”, the similarity calculation unit 130 calculates a high similarity for information on the first to second lines of the user 240 with the user identification information: 20002 with respect to information on the third to fourth lines of the user 210 with the user identification information: 10001.

Furthermore, for example, in a case where the feature amount 300 is “combination of purchased product 1 and purchased product 2”, the similarity calculation unit 130 calculates a high similarity for information on the first to second lines of the user 240 with the user identification information: 20002 with respect to information on the second to third lines of the user 210 with the user identification information: 10001. At this time, the similarity calculation unit 130 may calculate the similarity in consideration of the presence or absence of coupon use for the purchased product.

When a similarity 310 is larger than a predetermined value, the advertisement information creation unit 140 performs the following processing based on the analysis result obtained by analyzing the first user information 220 in a period after an observation period of the second processing target information 260. The advertisement information creation unit 140 creates the advertisement information 320 for providing notification of one advertisement application 330 capable of receiving an advertisement installed in the user terminal 270 identified by the user terminal identification information 280.

The analysis by the advertisement information creation unit 140 is an analysis for creating the advertisement information 320 expected to have a high effect from the first user information 220.

The advertisement information creation unit 140 may extract the information 340 related to the preference tendency of one user 210 as the analysis result of the first user information 220, and create the advertisement information 320 related to the product or service conforming to the preference tendency 340 of one user 210. As illustrated in FIG. 4, for example, when one user 210 turns 38, the advertisement information creation unit 140 extracts the preference tendency 340 of one user 210 that one user 210 purchases “health food” or “tea” which is health-conscious food from “noodle” or “beer”.

Then, the advertisement information creation unit 140 creates the advertisement information 320 related to “health food” or “tea” based on the extracted preference tendency 340. At that time, the advertisement information creation unit 140 may extract only the “health food” for which a coupon can be used as the information 340 related to the preference tendency of one user 210 in consideration of the information related to the usage status of the coupon 350 used for marketing of the product or service.

The advertisement information creation unit 140 may create the advertisement information 320 related to a product or service estimated to have contributed to improvement of an index 380 in the purchase behavior history 360 in an analysis target period of one user 210 based on the analysis result that the index 380 representing the health condition of one user 210 is improved.

As illustrated in FIG. 4, for example, the advertisement information creation unit 140 extracts that the reason why the health index 1 of one user 210 has changed from “poor” to “good” is that a dietary life has been changed from “noodle” or “beer” which is high-calorie food to “health food” or “tea” which is health-conscious food. Then, the advertisement information creation unit 140 creates the advertisement information 320 related to “health food” or “tea” based on the analysis result.

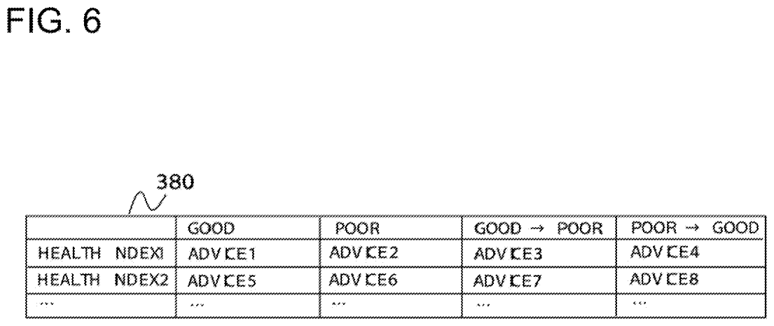

The advertisement information creation unit 140 may include a reason why the index 380 is improved and a recommendation for improving the index 380 in the advertisement information 320. As illustrated in FIG. 6, for example, since the health index 1 of one user 210 is changed from “poor” to “good”, the advertisement information creation unit 140 extracts “advice 3” as the reason why the index 380 is improved and the recommendation for improving the index 380, and includes the reason and the recommendation in the advertisement information 320.

In addition, the advertisement information creation unit 140 may create the advertisement information 320 related to a product or service that can be expected to improve the index 380 that is deteriorated, based on the analysis result that the index 380 representing the health condition of one user 210 is deteriorated.

As shown in FIG. 4, for example, the advertisement information creation unit 140 analyzes that the reason why “poor” state of the health index 2 of one user 210 continues is that there is intake of “noodle” or “beer” which is high-calorie food. Then, the advertisement information creation unit 140 extracts, as an analysis result, that it is better to change the dietary life to “health food” or “tea” which is health-conscious food in order to improve the “poor” state of the health index 2. Moreover, the advertisement information creation unit 140 creates the advertisement information 320 related to “health food” or “tea” based on the analysis result.

The advertisement information creation unit 140 may include, in the advertisement information 320, a reason why the index 380 is deteriorated and a recommendation for improving the index 380 that is deteriorated. As illustrated in FIG. 6, for example, since the “poor” state of the health index 2 of one user 210 continues, the advertisement information creation unit 140 extracts “advice 6” as the reason why the index 380 is deteriorated and the recommendation for improving the index 380 that is deteriorated, and includes the reason and the recommendation in the advertisement information 320.

The advertisement information notification unit 150 provides notification of the advertisement information 320 created by the advertisement information creation unit 140 by designating the user terminal identification information 280 and one advertisement application 330 stored in the second user information storage unit 120. The advertisement information notification unit 150 may instruct a server apparatus that manages the distribution of the advertisement information 320 to the advertisement application 330 to display the advertisement information 320 in the advertisement application 330 installed in the user terminal 270 identified by the user terminal identification information 280. Further, the advertisement information notification unit 150 may perform processing of displaying the advertisement information 320 in the advertisement application 330 installed in the user terminal 270 identified by the user terminal identification information 280.

Based on the operation principle described above, the present apparatus 100 can effectively utilize the time-series information 220 related to the behavior or characteristic of the preceding person 210 when creating the advertisement 320 for the following person 240.

### Hardware Configuration of Advertisement Apparatus According to Present Embodiment

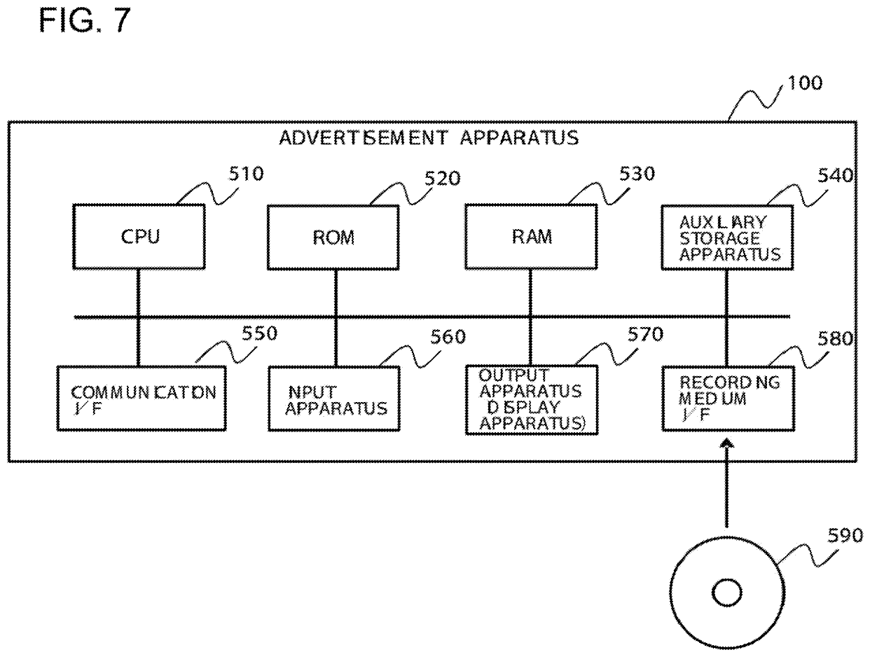

A hardware configuration example of the present apparatus 100 will be described with reference to FIG. 7. FIG. 7 is a diagram illustrating an example of a hardware configuration of the present apparatus 100. As illustrated in FIG. 7, the present apparatus 100 includes a central processing unit (CPU) 510, a read-only memory (ROM) 520, a random access memory (RAM) 530, an auxiliary storage apparatus 540, a communication I/F 550, an input apparatus 560, a display apparatus 570, and a recording medium I/F 580.

The CPU 510 is an apparatus that executes a program stored in the ROM 520, and performs arithmetic processing on data developed (loaded) in the RAM 530 according to an instruction of the program to control the entire present apparatus 100. The ROM 520 stores a program and data executed by the CPU 510. When the CPU 510 executes the program stored in the ROM 520, the RAM 530 develops (loads) the program and data to be executed, and temporarily holds operation data during operation.

The auxiliary storage apparatus 540 is an apparatus that stores an operating system (OS) that is basic software, an application program according to the present embodiment, and the like together with related data. The auxiliary storage apparatus 540 includes storage units 110 and 120 and is, for example, a hard disk drive (HDD) or a flash memory.

The communication I/F 550 is an interface that is coupled to the communication network 400 such as a wired or wireless local area network (LAN) and the Internet and exchanges data with the other apparatus 270 that provides a communication function.

The input apparatus 560 is an apparatus such as a keyboard for inputting data to the present apparatus 100. A display apparatus (output apparatus) 570 is an apparatus including a liquid crystal display (LCD) or the like, and functions as a user interface when the user uses the functions of the present apparatus 100 or performs various settings. The recording medium I/F 580 is an interface for transmitting and receiving data to and from the recording medium 590 such as a CD-ROM, a DVD-ROM, and a USB memory.

Each unit included in the present apparatus 100 may be implemented by the CPU 510 executing a program corresponding to each unit stored in the ROM 520 or the auxiliary storage apparatus 540. In addition, each unit included in the present apparatus 100 may be configured to implement processing related to each unit as hardware. In addition, the program according to the present invention may be read from an external server apparatus via the communication I/F 550, or the program according to the present invention may be read from the recording medium 590 via the recording medium I/F 580 to cause the present apparatus 100 to execute the program.

### Processing Example by Advertisement Apparatus According to Present Embodiment

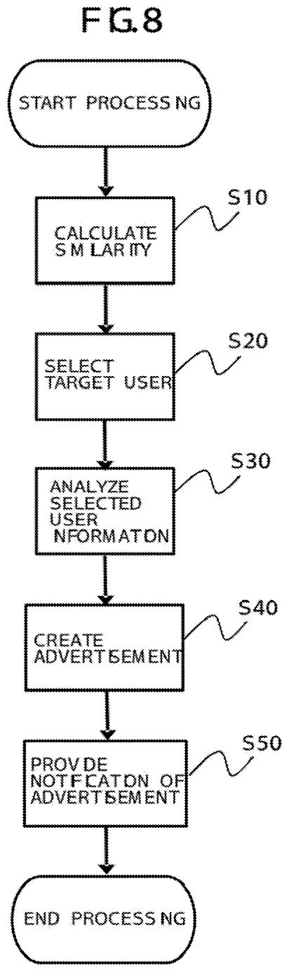

The flow of processing by the present apparatus 100 will be described with reference to FIG. 8. FIG. 8 is a flowchart illustrating a flow of a processing example by the present apparatus 100. The present apparatus 100 includes the first user information storage unit 110 and the second user information storage unit 120.

In S10, the similarity calculation unit 130 calculates the similarity between the first processing target information 230 and the second processing target information 260. The second processing target information 260 is the latest (latest period) information related to the predetermined feature amount 300 of the second user information 250. The first processing target information 230 is information related to the predetermined feature amount 300 of the first user information 220 in the same period as the second processing target information 260.

As illustrated in FIG. 2, the second processing target information 260 is information related to the second user information 250, and is information related to the predetermined feature amount 300 in a latest predetermined period. The first processing target information 230 is information related to the first user information 220, and is information related to the predetermined feature amount 300 in the same period as the second processing target information 260, extracted for processing by the similarity calculation unit 130.

As illustrated in FIGS. 4 and 5, for example, in a case where the feature amount 300 is “age”, the similarity calculation unit 130 calculates a high similarity for information on a second line of the user 240 with the user identification information: 20002 with respect to information on a second line of the user 210 with the user identification information: 10001. Similarly, for example, in a case where the feature amount 300 is “health index 2”, the similarity calculation unit 130 calculates a high similarity for information on the first to second lines of the user 240 with the user identification information: 20002 with respect to information on the third to fourth lines of the user 210 with the user identification information: 10001.

Furthermore, for example, in a case where the feature amount 300 is “combination of purchased product 1 and purchased product 2”, the similarity calculation unit 130 calculates a high similarity for information on the first to second lines of the user 240 with the user identification information: 20002 with respect to information on the second to third lines of the user 210 with the user identification information: 10001. At this time, the similarity calculation unit 130 may calculate the similarity in consideration of the presence or absence of coupon use for the purchased product.

In S20, the advertisement information creation unit 140 determines whether the similarity calculated in S10 is larger than a predetermined value. When the similarity calculated in S10 is larger than the predetermined value, the advertisement information creation unit 140 selects one user 210 and the other user 240 to be processed.

In S30, the advertisement information creation unit 140 performs the following processing on one user 210 and the other user 240 selected in S20. The advertisement information creation unit 140 analyzes the first user information 220 in a period after an observation period of the second processing target information 260. The analysis by the advertisement information creation unit 140 is an analysis for creating the advertisement information 320 expected to have a high effect from the first user information 220.

The advertisement information creation unit 140 extracts information 340 related to a preference tendency of one user 210 as the analysis result of the first user information 220. As illustrated in FIG. 4, for example, when one user 210 turns 38, the advertisement information creation unit 140 extracts the preference tendency 340 of one user 210 that one user 210 purchases “health food” or “tea” which is health-conscious food from “noodle” or “beer”.

Further, the advertisement information creation unit 140 may extract that the index 380 representing the health condition of one user 210 is improved as the analysis result of the first user information 220. As illustrated in FIG. 4, for example, the advertisement information creation unit 140 extracts that the reason why the health index 1 of one user 210 has changed from “poor” to “good” is that a dietary life has been changed from “noodle” or “beer” which is high-calorie food to “health food” or “tea” which is health-conscious food.

Further, the advertisement information creation unit 140 may extract that the index 380 representing the health condition of one user 210 is deteriorated as the analysis result of the first user information 220. As shown in FIG. 4, for example, the advertisement information creation unit 140 analyzes that the reason why “poor” state of the health index 2 of one user 210 continues is that there is intake of “noodle” or “beer” which is high-calorie food.

In S40, the advertisement information creation unit 140 creates the advertisement information 320 based on the analysis result in S30. The advertisement information creation unit 140 creates advertisement information 320 related to a product or service conforming to the preference tendency 340 of one user 210.

A case where the preference tendency 340 of one user 210 that the one user 210 purchases “health food” or “tea” which is health-conscious food from “noodle” or “beer” when one user 210 turns 38 is extracted, is as follows. As illustrated in FIG. 4, for example, the advertisement information creation unit 140 creates the advertisement information 320 related to “health food” or “tea” based on the extracted preference tendency 340. At that time, the advertisement information creation unit 140 may extract only the “health food” for which a coupon can be used as the information 340 related to the preference tendency of one user 210 in consideration of the information related to the usage status of the coupon 350 related to the product or service.

The advertisement information creation unit 140 may create the advertisement information 320 related to a product or service estimated to have contributed to improvement of the index 380 in the purchase behavior history 360 in the analysis target period of one user 210 based on the analysis result in S30.

A case where, as the reason why the health index 1 of one user 210 is changed from “poor” to “good”, it is extracted that the dietary life has been changed from “noodle” or “beer” which is high-calorie food to “health food” or “tea” which is health-conscious food, is as follows. As illustrated in FIG. 4, the advertisement information creation unit 140 creates advertisement information 320 related to “health food” or “tea” based on the analysis result.

The advertisement information creation unit 140 may include a reason why the index 380 is improved and a recommendation for improving the index 380 in the advertisement information 320. As illustrated in FIG. 6, for example, since the health index 1 of one user 210 is changed from “poor” to “good”, the advertisement information creation unit 140 extracts “advice 3” as the reason why the index 380 is improved and the recommendation for improving the index 380, and includes the reason and the recommendation in the advertisement information 320.

In addition, the advertisement information creation unit 140 may create the advertisement information 320 related to a product or service that can be expected to improve the index 380 that is deteriorated, based on the analysis result in S30.

A case where it is extracted as an analysis result that it is better to change the dietary life to “health food” or “tea” which is health-conscious food in order to improve the “poor” state of the health index 2, is as follows. As illustrated in FIG. 4, the advertisement information creation unit 140 creates advertisement information 320 related to “health food” or “tea” based on the analysis result.

The advertisement information creation unit 140 may include, in the advertisement information 320, a reason why the index 380 is deteriorated and a recommendation for improving the index 380 that is deteriorated. As illustrated in FIG. 6, for example, since the “poor” state of the health index 2 of one user 210 continues, the advertisement information creation unit 140 extracts “advice 6” as the reason why the index 380 is deteriorated and the recommendation for improving the index 380 that is deteriorated, and includes the reason and the recommendation in the advertisement information 320.

In S50, the advertisement information notification unit 150 provides notification of the advertisement information 320 created in S40 by designating the user terminal identification information 280 and one advertisement application 330 stored in the second user information storage unit 120.

The advertisement information notification unit 150 may instruct a server apparatus that manages the distribution of the advertisement information 320 to the advertisement application 330 to display the advertisement information 320. Further, the advertisement information notification unit 150 may perform processing of displaying the advertisement information 320 by itself.

By performing the processing as described above, the present apparatus 100 can effectively utilize the time-series information 220 related to the behavior or characteristic of the preceding person 210 when creating the advertisement 320 for the following person 240.

Although the embodiments of the present invention have been described in detail above, the present invention is not limited to the specific embodiments, and various modifications and changes can be made within the scope of the gist of the present invention described in the claims.

What is claimed is:

1. An advertisement apparatus comprising:
a first user information storage unit configured to store first user information that is time-series information related to a behavior or characteristic of one user;
a second user information storage unit configured to store second user information that is time-series information related to a behavior or characteristic of the other user and user terminal identification information that is information for specifying a user terminal when notification of an advertisement is provided by designating the user terminal operated by the other user and an application installed in the user terminal in association with each other;
a similarity calculation unit configured to calculate a similarity between second processing target information that is information related to a predetermined feature amount of the second user information and first processing target information that is information in the same period as the second processing target information related to the predetermined feature amount of the first user information;
an advertisement information creation unit configured to create, when the similarity is larger than a predetermined value, advertisement information for providing notification of one advertisement application capable of receiving an advertisement installed in the user terminal identified by the user terminal identification information based on an analysis result obtained by analyzing the first user information in a period after an observation period of the second processing target information; and
an advertisement information notification unit configured to provide notification of the advertisement information created by the advertisement information creation unit by designating the user terminal identification information and the one advertisement application.

2. The advertisement apparatus according to claim 1, wherein the advertisement information creation unit extracts information related to a preference tendency of the one user as the analysis result of the first user information, and creates the advertisement information related to a product or service conforming to the preference tendency of the one user.

3. The advertisement apparatus according to claim 2, wherein the information related to the preference tendency of the one user includes information related to a usage status of a coupon used for marketing of the product or service.

4. The advertisement apparatus according to claim 1, wherein the advertisement information creation unit creates, based on an analysis result that an index representing a health condition of the one user is improved, the advertisement information related to a product or service estimated to have contributed to improvement of the index in a purchase behavior history of the one user in an analysis target period.

5. The advertisement apparatus according to claim 4, wherein the advertisement information creation unit includes a reason why the index is improved and a recommendation for improving the index in the advertisement information.

6. The advertisement apparatus according to claim 1, wherein the advertisement information creation unit creates the advertisement information related to the product or service that can be expected to improve an index that is deteriorated based on an analysis result that the index representing a health condition of the one user is deteriorated.

7. The advertisement apparatus according to claim 6, wherein the advertisement information creation unit includes, in the advertisement information, a reason why the index is deteriorated and a recommendation for improving the index that is deteriorated.

8. An advertisement method comprising:
calculating, by a similarity calculation unit, a similarity between second processing target information and first processing target information, the second processing target information being information related to a predetermined feature amount of second user information stored in a second user information storage unit that stores, the second user information that is time-series information related to a behavior or characteristic of the other user and user terminal identification information that is information for specifying a user terminal in a case where notification of an advertisement is provided by designating the user terminal operated by the other user and an application installed in the user terminal in association with each other, and the first processing target information being information in the same period as the second processing target information related to the predetermined feature amount of the first user information stored in a first user information storage unit that stores the first user information that is time-series information related to a behavior or characteristic of one user;
creating, by an advertisement information creation unit, when the similarity is larger than a predetermined value, advertisement information for providing notification of one advertisement application capable of receiving an advertisement, installed on the user terminal identified by the user terminal identification information based on an analysis result obtained by analyzing the first user information in a period after an observation period of the second processing target information; and
providing notification, by advertisement information notification unit, of the advertisement information created by the advertisement information creation unit by designating the user terminal identification information and the one advertisement application.

9. The advertisement method according to claim 8, wherein the advertisement information creation unit extracts information related to a preference tendency of the one user as the analysis result of the first user information, and creates the advertisement information related to a product or service conforming to the preference tendency of the one user.

10. The advertisement method according to claim 9, wherein the information related to the preference tendency of the one user includes information related to a usage status of a coupon used for marketing of the product or service.

11. The advertisement method according to claim 8, wherein the advertisement information creation unit creates, based on an analysis result that an index representing a health condition of the one user is improved, the advertisement information related to a product or service estimated to have contributed to improvement of the index in a purchase behavior history of the one user in an analysis target period.

12. The advertisement method according to claim 11, wherein the advertisement information creation unit includes a reason why the index is improved and a recommendation for improving the index in the advertisement information.

13. The advertisement method according to claim 8, wherein the advertisement information creation unit creates the advertisement information related to the product or service that can be expected to improve an index that is deteriorated based on an analysis result that the index representing a health condition of the one user is deteriorated.

14. The advertisement method according to claim 13, wherein the advertisement information creation unit includes, in the advertisement information, a reason why the index is deteriorated and a recommendation for improving the index that is deteriorated.

15. An advertisement program for causing a computer to execute the method according to claim 8.
